(19) United States
(12) Patent Application Publication
(10) Pub. No.: US 2026/0077477 A1
(43) Pub. Date: Mar. 19, 2026

(54) ROBOT AND ROBOT MANUFACTURING METHOD

(71) Applicant: CASIO COMPUTER CO., LTD., Tokyo (JP)

(72) Inventor: Koji YUKI, Tokyo (JP)

(73) Assignee: CASIO COMPUTER CO., LTD., Tokyo (JP)

(21) Appl. No.: 19/278,655

(22) Filed: Jul. 23, 2025

(30) Foreign Application Priority Data
Sep. 19, 2024 (JP) 2024-162641

(51) Int. Cl. B25J 9/00; B25J 19/00

(52) U.S. Cl. CPC B25J 9/0009; B25J 19/007; B25J 19/0075

(57) ABSTRACT

A robot includes an exterior, a body, and a plate-shaped member (fixing member). The body is covered by the exterior and is provided with a screw hole (attachment receiver), a first protrusion (engager), and a second protrusion (engager). The plate-shaped member is fixed to the inner surface of the exterior, and includes a through-hole (attacher) disposed at a position where the screw hole (attachment receiver), a hole (engagement receiver) with which a first protrusion is engaged, and a notch (engagement receiver) with which a second protrusion is engaged. Engagement of the first protrusion and the second protrusion with a hole and a notch positions the plate-shaped member relative to the body.

### CROSS-REFERENCE TO RELATED APPLICATIONS

This application is based upon and claims the benefit of priority under 35 USC 119 of Japanese Patent Application No. 2024-162641, filed on Sep. 19, 2024, the entire disclosure of which, including the description, claims, drawings, and abstract, is incorporated herein by reference in its entirety.

### FIELD OF THE INVENTION

The present disclosure relates to a robot and a robot manufacturing method.

### BACKGROUND OF THE INVENTION

In, for example, Unexamined Japanese Patent Application Publication No. 2019-162715, a pet robot is disclosed that includes an exterior detachable so as to cover a body of the robot, in order to present the robot as a familiar presence such as a pet.

A robot according to the present disclosure includes an exterior, a body covered by the exterior and provided with an attachment receiver and an engager, and a fixing member provided on an inner surface of the exterior and including an attacher disposed at a position where the attachment receiver is formed and an engagement receiver with which the engager is engaged. Engagement of the engager with the engagement receiver positions the fixing member relative to the body.

### BRIEF DESCRIPTION OF DRAWINGS

A more complete understanding of this application can be obtained when the following detailed description is considered in conjunction with the following drawings, in which:

FIG. 1 is a perspective view of a robot according to Embodiment 1 of the present disclosure;

FIG. 2 is a cross-sectional view of the robot according to Embodiment 1;

FIG. 3 is a cross-sectional view of the robot according to Embodiment 1;

FIG. 4 is a cross-sectional view illustrating a state in which a line fastener is open, according to Embodiment 1;

FIG. 5 is a perspective view illustrating positional relationships of plate-shaped members according Embodiment 1;

FIG. 6 is an enlarged view of a portion “VI” of FIG. 3;

FIG. 7 is an enlarged view of a portion “VI” of FIG. 4;

FIG. 8 is a rea view illustrating a state in which the line fastener is open, according to Embodiment 1;

FIG. 9 is a cross-sectional view of the plate-shaped member according to Embodiment 1;

FIG. 10 is a perspective view illustrating an attachment method of the plate-shaped member according to Embodiment 1;

FIG. 11 is a perspective view illustrating an attachment method of the plate-shaped member according to Embodiment 1;

FIG. 12 is a perspective view illustrating an attachment method of the plate-shaped member according to Embodiment 1;

FIG. 13 is an enlarged view of a portion “X” of FIG. 3;

FIG. 14 is perspective view illustrating the plate-shaped member and a protrusion-shaped part according to Embodiment 1, with the plate-shaped member and the protrusion-shaped part not engaged with each other;

FIG. 15 is perspective view illustrating the plate-shaped member and the protrusion-shaped part according to Embodiment 1, with the plate-shaped member and the protrusion-shaped part engaged with each other;

FIG. 16 is a cross-sectional enlarged view of a portion corresponding to a “XII” portion of FIG. 3, with a protrusion and an insertion hole being in a non-engaged state;

FIG. 17 is a flowchart illustrating a robot manufacturing method according to an embodiment of the present disclosure;

FIG. 18 is a cross-sectional view for explaining an effect of the plate-shaped member according to Embodiment 1;

FIG. 19 is a cross-sectional view taken along line A-A of FIG. 18;

FIG. 20 is a cross-sectional view for explaining an effect of a plate-shaped member according to Embodiment 2;

FIG. 21 is a cross-sectional view for explaining an effect of a plate-shaped member according to Embodiment 2;

FIG. 22 is an exploded perspective view of a body, a plate-shaped member, and an attachment member according to Embodiment 3;

FIG. 23 is a cross-sectional view for explaining an effect of a plate-shaped member according to Embodiment 3;

FIG. 24 is a cross-sectional view for explaining an effect of a plate-shaped member according to Embodiment 3;

FIG. 25 is a perspective view illustrating positional relationships of plate-shaped members according Embodiment 4;

FIG. 26 is a cross-sectional view of a body, an exterior, and other components according to Embodiment 4; and

FIG. 27 is a perspective view illustrating positional relationships of plate-shaped members according Embodiment 5.

### DETAILED DESCRIPTION OF THE INVENTION

Embodiment 1 of the present disclosure is hereinafter described with reference to the drawings. In order to facilitate comprehension of Embodiment 1, XYZ coordinates orthogonal to each other are set and appropriately referenced. The Y-axis direction of the XYZ coordinates represents a front-rear direction of a robot 1 imitating a small animal. The Y-axis direction has a −Y-axis direction representing a forward direction to the front of the robot 1, and a +Y-axis direction representing a backward direction to the rear of the robot 1. The Z-axis direction represents a height direction of the robot 1 and the X-axis direction is a width direction of the robot 1.

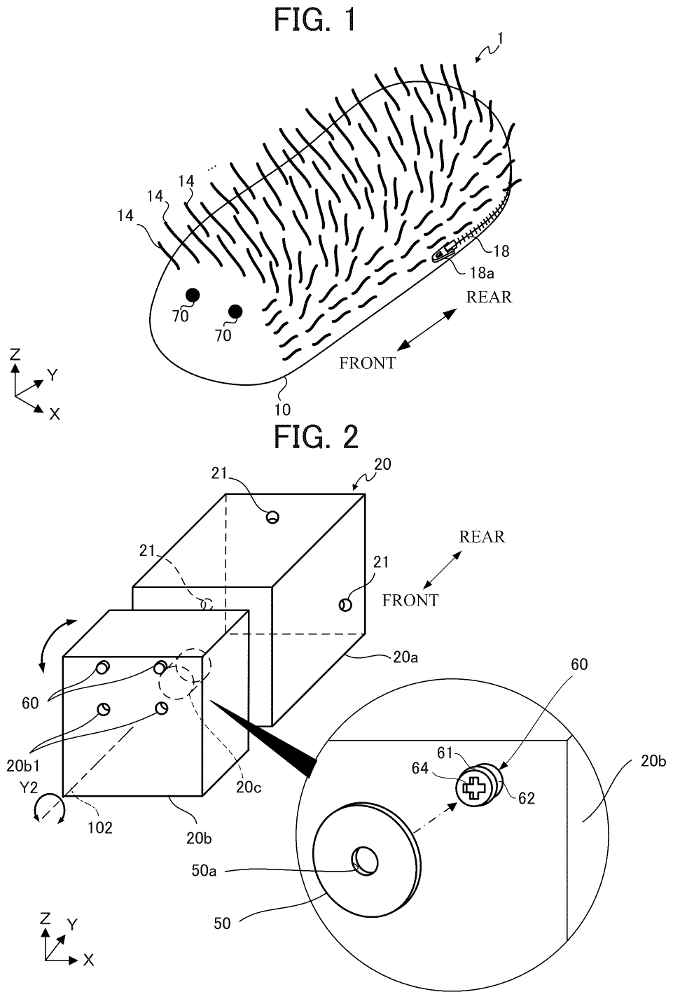

As illustrated in FIGS. 1 and 2, two decoration parts 70, each including a decoration imitating the eye of the small animal, are provided on the front side of the robot 1. A face portion of the small animal is formed on the front side of the robot 1. The robot 1 includes an exterior 10, a body 20 covered by the exterior 10, a plate-shaped member 30 (fixing member), a screw 40 (attachment member), a plate-shaped member 50, a protrusion-shaped part 60, and the decoration parts 70.

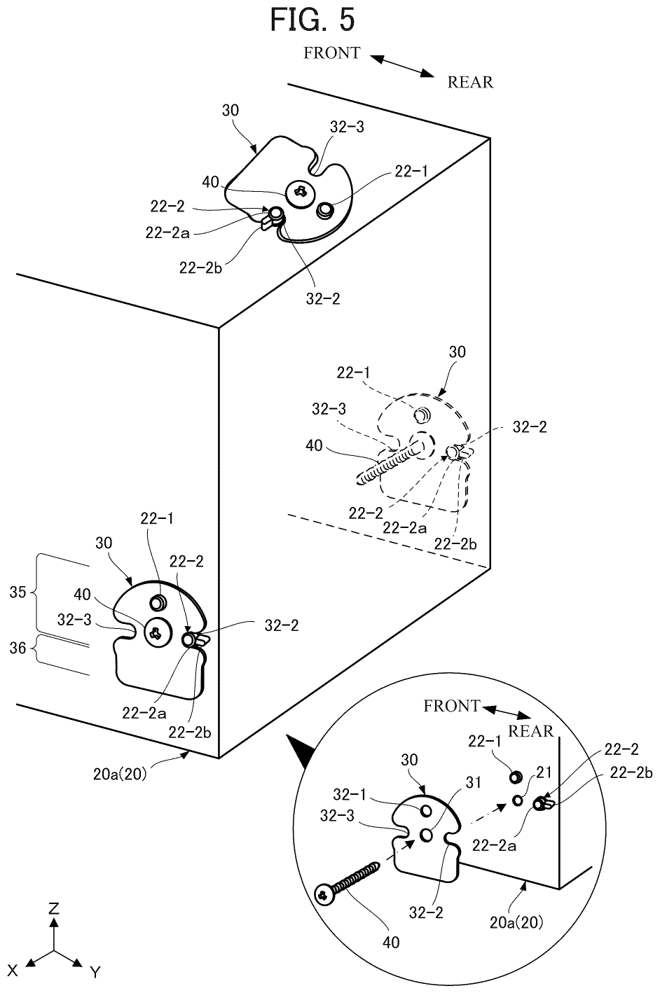

The body 20 is made of, for example, white synthetic resin and includes, as illustrated in FIGS. 2 to 4, a torso 20a, a head 20b, and a joint 20c. The torso 20a has a shape that is long in the front-rear direction (Y-axis direction), and is placed on a placement surface 101 of a floor, a table, or the like with the exterior 10 therebetween. A label that indicates a serial number, a rating, or a certification standard as individual information is attached to the rear surface of the torso 20a. A non-illustrated power button is provided at the rear of the torso 20a. As illustrated in FIGS. 5, 6, and 7, screw holes 21 (attachment receivers), first protrusions 22-1 (engagers), and second protrusions 22-2 (engagers) are formed at the rear of the torso 20a.

Three screw holes 21 (attachment receivers) are formed at the rear of the torso 20a. The plate-shaped members 30 provided on the exterior 10 engage with the screw holes 21 formed on the torso 20a using screw 40 that are Y-shaped pins, which are specialized screws. This enables the exterior 10 to move in accordance with the operation of the body 20 in Embodiment 1. Three first protrusions 22-1 (engagers) are provided near their three respective screw holes 21. In Embodiment 1, the first protrusions 22-1 are formed protruding from the surface of the torso 20a and are shaped as cylinders with a perfectly round cross-section. Three second protrusions 22-2 (engagers) are formed near their three respective screw holes 21. In Embodiment 1, each second protrusion 22-2 is shaped to include a cylindrical section 22-2a and a projecting part 22-2b extending radially from the cylindrical section 22-2a. Thus, the second protrusions 22-2 in Embodiment 1 are formed into a shape different from the first protrusions 22-1.

As illustrated in FIGS. 1 and 2, the head 20b is a part corresponding to the head of the robot 1 imitating a small animal. Two insertion holes 20b1 are formed at the front of the head 20b, and decoration parts 70 imitating the eyes of the small animal are inserted into the insertion holes 20b1. Additionally, two protrusion-shaped parts 60 that engage with plate-shaped members 50 provided to the exterior 10 are attached above the two insertion holes 20b1 so as to correspond with the insertion holes 20b1. By engaging the plate-shaped members 50 provided to the exterior 10 with the protrusion-shaped parts 60 attached to the head 20b, the exterior 10 can be caused to move together with the movement of the body 20.

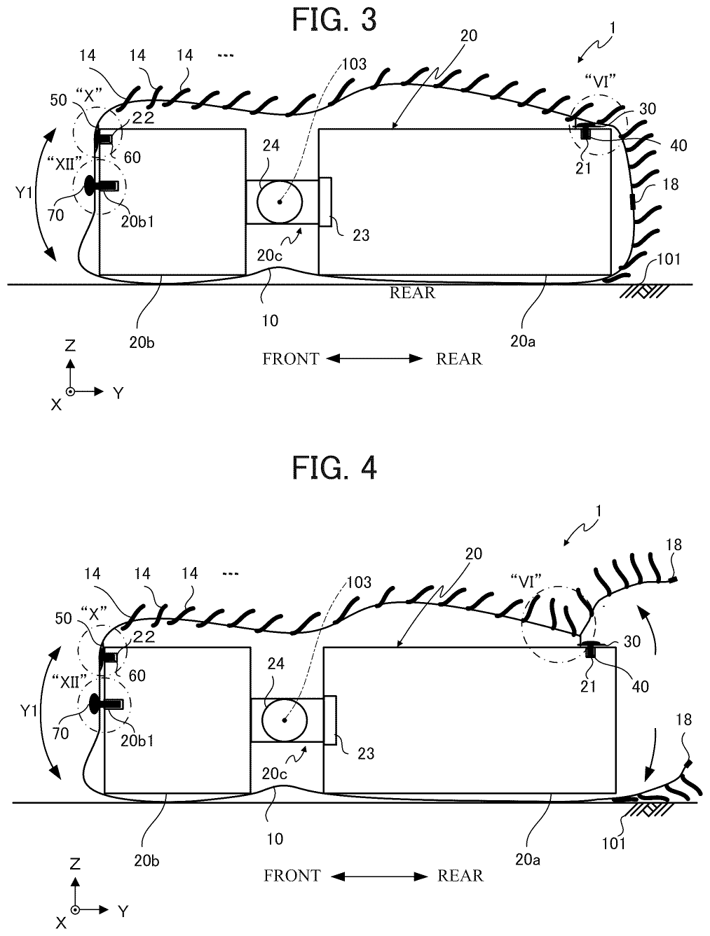

The joint 20c couples a rear end portion of the head 20b to a front end portion of the torso 20a. A twist motor 23 and a vertical motor 24 are provided in the joint 20c. As illustrated in FIG. 2, the twist motor 23 rotates the head 20b in the direction of arrow Y2 around an axis 102 extending in the front-rear direction. Such movement of the head 20b can cause the robot 1 imitating a small animal to perform a gesture of tilting the head. As illustrated in FIGS. 3 and 4, the vertical motor 24 rotates the head 20b in the direction illustrated as arrow Y1 around an axis 103 parallel to the X-axis direction. Such movement of the head 20b can cause the robot 1 imitating a small animal illustrated in FIG. 1 to perform a gesture of shaking the head up and down. Thus, the joint 20c couples the head 20b to the torso 20a such that the head 20b is capable of movement on two axes, namely rotation by the twist motor 23 and rotation by the vertical motor 24.

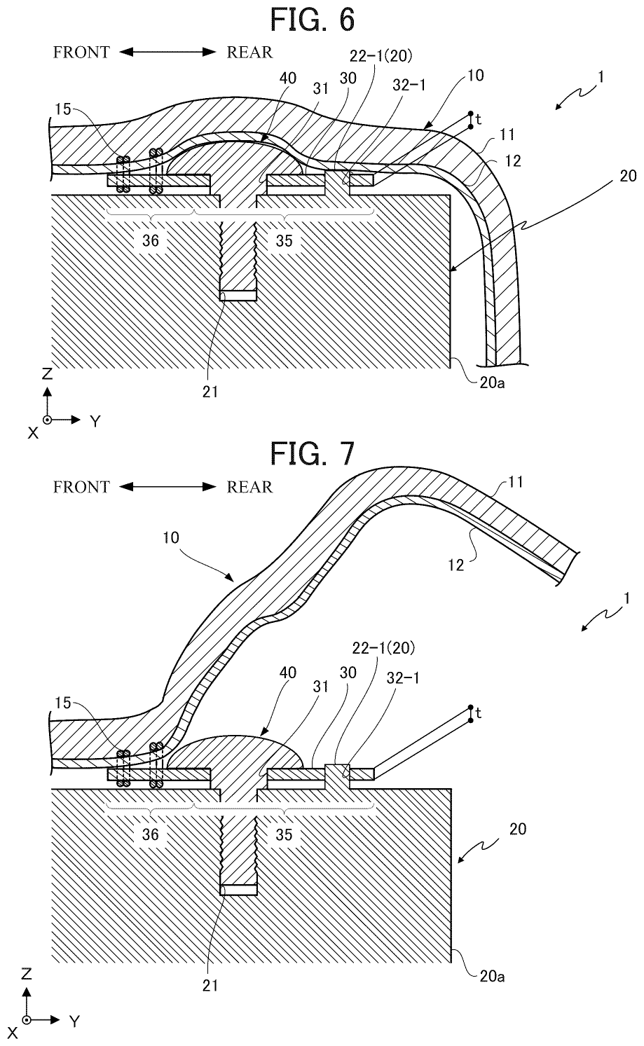

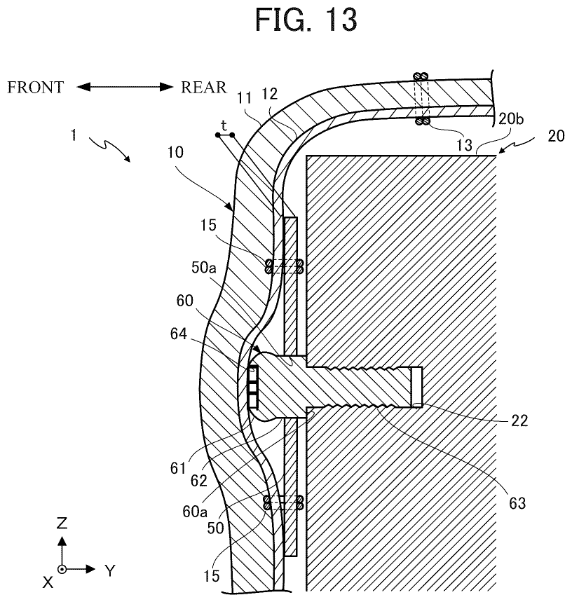

As illustrated in FIGS. 3 and 4, the exterior 10 has a shape of a bag that is long in the front-rear direction, has an opening formed in a rear portion thereof, and is capable of accommodating the body 20 therein. As illustrated in FIGS. 6 and 7, this exterior 10 is formed such that a sheet-like outer fabric 11 and a lining 12 are stacked on each other. As illustrated in FIGS. 1 and 3, the outer fabric 11 is formed from an artificial pile fabric that imitates fur 14 of a small animal. This allows the texture of the robot 1 to resemble the texture of a small animal. However, the material of the outer fabric 11 is not limited thereto. The outer fabric 11 may also be made from materials other than a pile fabric. Nonetheless, from the perspective of the texture of the robot 1, the outer fabric 11 is preferably made of pile fabric. Note that, to prevent unnecessary complexity in the drawings, the depiction of the fur 14 is omitted in FIGS. 6 and 7, and FIGS. 13 and 16 described later. The lining 12 is formed from a woven fabric obtained by weaving synthetic fibers. However, the material of the lining 12 is not limited thereto. The lining 12 may be formed from natural leather, artificial leather, a sheet material made of synthetic resin, a sheet material made of rubber, or a fabric made of natural fibers. The outer fabric 11 and the lining 12 are sewn together by thread 13 at positions such as near the head 20b of the body 20, as illustrated in FIG. 13 described later. As illustrated in FIGS. 3 and 4, the plate-shaped members 30 and 50 are sewn to the inner side of the exterior 10.

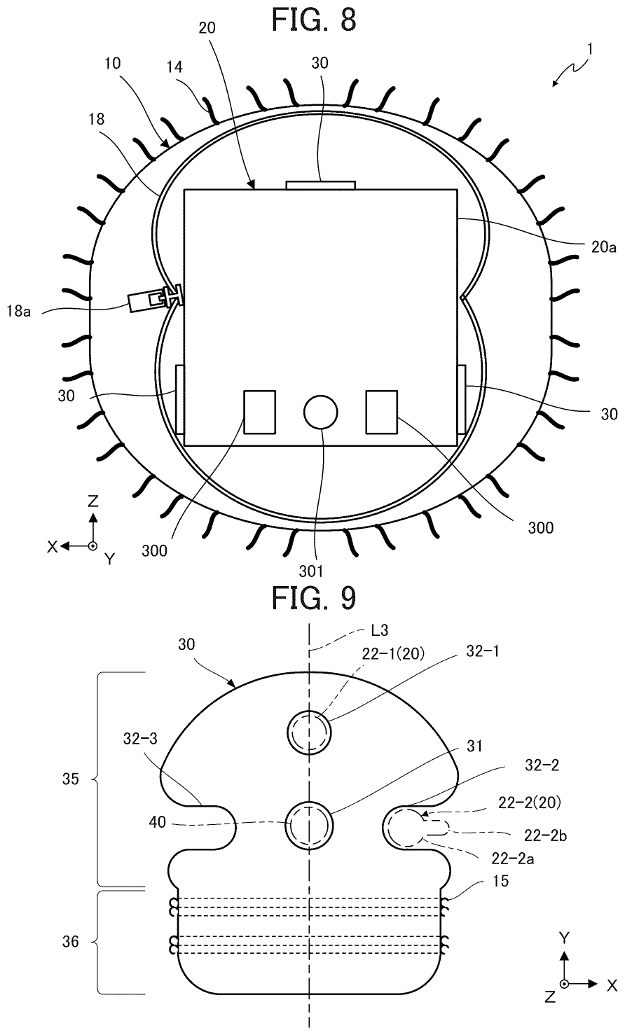

As illustrated in FIGS. 1 and 3, a line fastener 18 (fastener) is attached to the rear of the exterior 10 as a fastener capable of opening and closing the opening of the exterior 10. By sliding a slider 18a to a closed state while the body 20 is accommodated in the exterior 10, a state in which the body 20 is accommodated is maintained. By sliding the slider 18a to open the line fastener 18, an opening is formed, allowing the body 20 accommodated inside to be removed or inserted into the interior of the exterior 10. By opening the line fastener 18, as illustrated in FIGS. 4 and 8, the exterior 10 can be rolled up, and a portion of the exterior 10 can be removed from the body 20. A label 300 expressing product information and a power button 301 are provided at positions that are exposed to the outside through the opening, at the opening formed by opening the line fastener 18 and removing the portion of the exterior 10 from the body 20.

As illustrated in FIGS. 2 and 3, in the body 20 and the exterior 10 formed as described above, the exterior 10 is caused to move in accordance with the movement of the body 20 resulting from the driving of the twist motor 23 and the vertical motor 24 and, as such, the robot 1 that imitates a small animal can be caused to move as if alive. In order to realize this, the exterior 10 is appropriately locked to the body 20 using the decoration parts 70 and the plate-shaped members 50, and the insertion holes 20b1 and the protrusion-shaped parts 60, so as to cause the exterior 10 to conform to the movement of the body 20. Furthermore, the exterior 10 is appropriately locked to the body 20 by screwing the screw 40 into a through-hole 31 of each of the plate-shaped members 30 and also fitting the screw 40 into each of the screw holes 21 of the torso 20a and, as a result, the exterior 10 is caused to conform to the movement of the body 20.

Next, a method of locking the exterior 10 to the body 20 accommodated in the exterior 10 is described in detail. The three screw holes 21 provided in the body 20 illustrated in FIGS. 2 and 3 all have the same configuration, and the two protrusion-shaped parts 60 provided to the body 20 have the same configuration. The three plate-shaped members 30 and the two plate-shaped members 50 provided to the exterior 10 all have the same configuration. As such, in the following, the configurations of the screw hole 21 and the plate-shaped member 30 of “VI” of FIGS. 3 and 4, and the protrusion-shaped part 60 and the plate-shaped member 50 of “X” of FIGS. 3 and 4 are described.

As illustrated in FIGS. 3 and 4, the plate-shaped member 30 (fixing member) is a snap provided, on the inner surface of the exterior 10, at a position capable of being fixed to the screw hole 21. Specifically, the plate-shaped member 30 is sewn to the inner side of the exterior 10. The plate-shaped member 30 is, for example, made from polyamide 6 (PA6) having a thickness t of 0.5 mm. As illustrated in FIG. 9, the plate-shaped member 30 is formed to be symmetric (left-right symmetric) along a central line L3 parallel to the Z-axis direction. The plate-shaped member 30 has a hole-forming section 35 and a sewing section 36.

The hole-forming section 35 includes a through-hole 31 (attacher), a hole 32-1 (engagement receiver), a notch 32-2 (engagement receiver), and a notch 32-3. The screw 40 (attachment member) is inserted in the through-hole 31. The through-hole 31 is formed to penetrate in the thickness direction (Z-axis direction) of the plate-shaped member 30. In Embodiment 1, the through-hole 31 is a circular hole with a perfectly round XY cross-section. The hole 32-1 (engagement receiver) is designed to fit the first protrusion 22-1 (engager) of the body 20. Specifically, in Embodiment 1, the first protrusion 22-1 of the body 20 is press-fitted into the hole 32-1. By adjusting this press-fit force, the positioning in the thickness direction (Z-axis direction) of the plate-shaped member 30 can be achieved. The hole 32-1 penetrates in the thickness direction (Z-axis direction) of the plate-shaped member 30. In Embodiment 1, the hole 32-1 is a circular hole with a perfectly round XY cross-section. As illustrated in FIG. 9, this hole 32-1 is located outward on the +Y side relative to the position of the through-hole 31. The notch 32-2 (engagement receiver) is designed to fit the second protrusion 22-2 (engager) of the body 20. In Embodiment 1, the second protrusion 22-2 of the body 20 is fitted into the notch 32-2 in a non-press-fit state. This notch 32-2 is formed to penetrate in the thickness direction (Z-axis direction) of the plate-shaped member 30 and is formed as a notch. In FIG. 9, this notch 32-2 is positioned outward on the +X side relative to the position of the through-hole 31. Additionally, in Embodiment 1, the notch 32-2 is shaped to allow the second protrusion 22-2 to fit in the notch 32-2. For this reason, in Embodiment 1, the notch 32-2 is designed with a shape different from that of the hole 32-1. The notch 32-3 is also formed to penetrate in the thickness direction (Z-axis direction) of the plate-shaped member 30 and is formed as a notch. In FIG. 9, this notch 32-3 is positioned outward on the −X side relative to the position of the through-hole 31. In Embodiment 1, unlike the notch 32-2, this notch 32-3 is not used for fitting protrusions or similar purposes.

The sewing section 36, as illustrated in FIGS. 6, 7, and 9, refers to a portion where thread 15 is sewn to the exterior 10. This sewing section 36 is only sewn to the lining 12 of the exterior 10 using thread 15, and is not sewn to the outer fabric 11. The sewing onto the lining 12 of the sewing section 36 is performed before the lining 12 and the outer fabric 11 are sewn together. As described above, since the plate-shaped member 30 is flat and free of steps, and the thickness t of the plate-shaped member 30 is 0.5 mm, there are no significant steps between the plate-shaped member 30 and the lining 12 that would cause issues when sewing the sewing section 36 of the plate-shaped member 30 to the lining 12 using a sewing machine. For this reason, the sewing of the sewing section 36 of the plate-shaped member 30 is performed with a sewing machine for ease of operation.

The screw 40 (attachment member) is a part for fixing the plate-shaped member 30 to the body 20 by being screwed into the screw hole 21 (attachment receiver). As illustrated in FIG. 5, the screw hole 21 into which screw 40 is screwed is formed near the upper side and both side surfaces of the rear area of torso 20a (+X-side surface and −X-side surface). The diameter of the through-hole 31 where the screw 40 is inserted is larger than the diameter of the shaft of the screw 40 and smaller than the diameter of the head of the screw 40. The diameter of the through-hole 31 where the screw 40 is inserted is designed to be large enough that the plate-shaped member 30 does not come off from the screw 40 even if the plate-shaped member 30 is deformed.

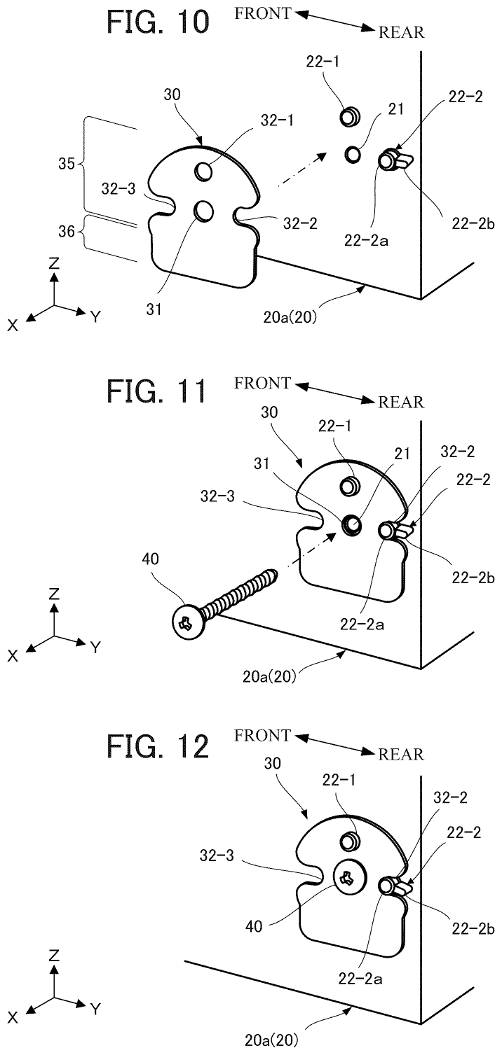

Next, a method of fixing the plate-shaped member 30 to the body 20 is described using FIGS. 10 to 12. First, as illustrated in FIG. 10, an operator fits the first protrusion 22-1 formed on the body 20 into the hole 32-1 formed in the plate-shaped member 30. This allows the operator to position the plate-shaped member 30 relative to the body 20. In Embodiment 1, the first protrusion 22-1 of the body 20 is press-fitted into the hole 32-1. By adjusting the amount of this press-fit, the operator can also position the plate-shaped member 30 in the plate-thickness direction (Z-axis direction). The operator also fits the second protrusion 22-2 formed on the body 20 into the notch 32-2 formed on the plate-shaped member 30. This prevents rotation of the plate-shaped member 30 around the X-axis relative to the body 20. By fitting the first protrusion 22-1 into the hole 32-1 and the second protrusion 22-2 into the notch 32-2, as illustrated in FIG. 11, the through-hole 31 of the plate-shaped member 30 is aligned coaxially with the screw hole 21 of the body 20. This aligns the through-hole 31 of the plate-shaped member 30 with the screw hole 21 of the body 20.

Subsequently, the operator inserts the screw 40 into the through-hole 31 of the plate-shaped member 30 and screws it into the screw hole 21 of the body 20. Then, as illustrated in FIG. 12, the operator presses the head of the screw 40 against the plate-shaped member 30, completing the task of securing the plate-shaped member 30 to the body 20. Note that the plate-shaped member 30 is fixed to the body 20 by the screw 40. Thus, unless work to remove the screw 40 is performed with a clear intent to detach the plate-shaped member 30 from the torso 20a, the plate-shaped member 30 does not easily separate from the body 20. Furthermore, the screw 40 is a Y-pin and cannot be removed without using a specialized screwdriver. As illustrated in FIG. 2, the screw holes 21 are formed in three locations in the torso 20a of the body 20. As illustrated in FIG. 3, the plate-shaped member 30 is sewn to the exterior 10, covering the body 20, at a position corresponding to each screw hole 21. That is, the attaching of the exterior 10 to the body 20 is performed using the plate-shaped member 30 and the screw hole 21 at a total of three locations. By performing such attaching of the exterior 10 at a plurality of locations in this manner, the exterior 10 can be made to conform to the movement of the body 20, and the robot 1 that imitates a small animal can be made to perform gestures as if alive.

The plate-shaped member 50, as illustrated in FIGS. 13, 14, and 15, is a snap positioned on the inner surface of the exterior 10 to be fixable to an insertion hole 22. Specifically, the plate-shaped member 50 is sewn onto the inside of the exterior 10. The plate-shaped member 50 is formed, for example, from polyamide 6 (PA6) with a thickness of t=0.5 mm. The plate-shaped member 50 is molded into a circular disk shape, for example. The diameter of the plate-shaped member 50 is, for example, 16 mm. Additionally, a round hole 50a, through which the protrusion-shaped part 60 is inserted and fitted, is formed at the center of the plate-shaped member 50. As illustrated in FIG. 13, the plate-shaped member 50 is sewn only to the lining 12 of the exterior 10 using thread 15 and not to the outer fabric 11. The sewing of the plate-shaped member 50 to the lining 12 is performed together with the plate-shaped member 30 before the lining 12 and outer fabric 11 are sewn to each other using a sewing machine. For example, as illustrated in FIG. 14, the sewing of the plate-shaped member 50 to the lining 12 is performed along two straight parallel lines L1 and L2 around the round hole 50a. As described above, by setting the diameter of the plate-shaped member 50 to 16 mm, a sewing distance needed to ensure the sewing strength of the plate-shaped member 50 can be ensured. Here, the term “sewing distance” is the length of the portion of the plate-shaped member 50 sewn using the thread 15, that is, is the total of the lengths of the lines L1 and L2.

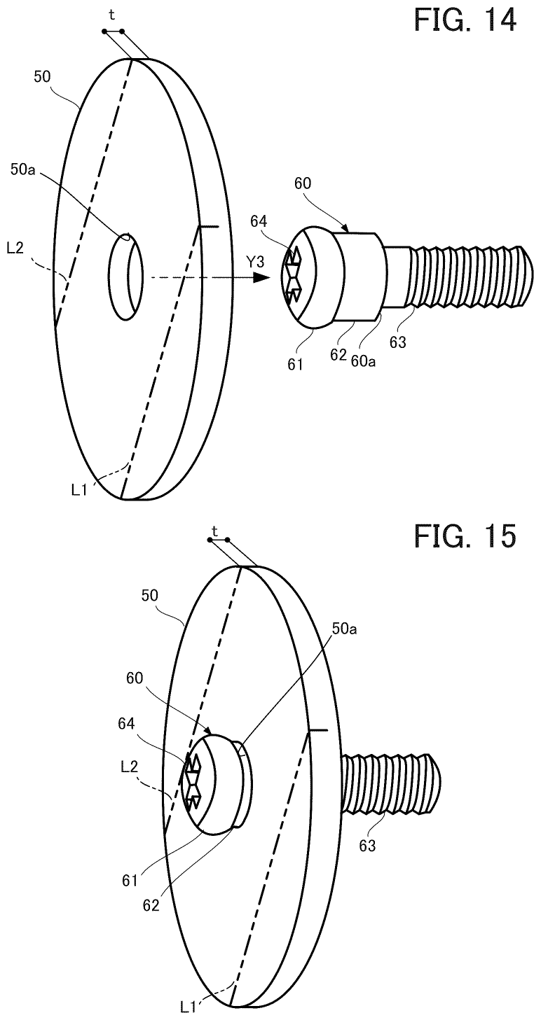

The protrusion-shaped part 60, as illustrated in FIGS. 13, 14, and 15, is a screw-shaped part for fixing the plate-shaped member 30 to the body 20 by being screwed into the insertion hole 22. As illustrated in FIG. 14, the protrusion-shaped part 60 includes a head 61 on which a plus-symbol groove 64 is formed, a cylindrical connecting portion 62, and a shaft 63 with male threads. Additionally, as illustrated in FIG. 13, an insertion hole 52 in which the male threads of the shaft 63 are mated is formed in the torso 20a. The head 61 has the largest diameter among diameters of portions of the protrusion-shaped part 60. The connecting portion 62 between the head 61 and the shaft 63 has a smaller diameter than the head 61 and a larger diameter than the insertion hole 22. Thus, as the protrusion-shaped part 60 is tightened into the insertion hole 22 using a screwdriver, the lower end 62a of the connecting portion 62 illustrated in FIG. 14 eventually contacts the main body 20, preventing further tightening. By tightening the protrusion-shaped part 60 to the body 20 until the lower end 62a of the connecting portion 62 contacts the main body 20, the attachment of the protrusion-shaped part 60 to the body 20 is completed. The attached protrusion-shaped part 60, as illustrated in FIG. 13, protrudes from the body 20 by a height equal to the combined heights of the head 61 and the connecting portion 62. As illustrated in FIGS. 13 and 15, the head 61 has a bulging shape whereby the diameter is smallest at both end portions in the longitudinal direction of the protrusion-shaped part 60, and is greatest at a center portion in the longitudinal direction. The diameter of the portion of the head 61 connecting to the connecting portion 62 is equal to that of the cylindrical connecting portion 62.

The diameter of the round hole 50a formed in the plate-shaped member 50 is about 0.2 mm smaller than the diameter of the connecting portion 62 of the protrusion-shaped part 60. When engaging the plate-shaped member 50, having this round hole 50a formed therein, with the protrusion-shaped part 60, firstly, as illustrated by arrow Y3 of FIG. 14, the plate-shaped member 50 is brought near to the protrusion-shaped part 60. Then, the round hole 50a formed in the plate-shaped member 50 is pressed against and passed over the head 61, which is the large diameter portion. Then, as illustrated in FIG. 15, the round hole 50a is fitted on the connecting portion 62, which is the small diameter portion. The plate-shaped member 50 is made of a material that has a small amount of elasticity and, as such, the round hole 50a can pass over the head 61, which is the large diameter portion. As illustrated in FIGS. 13 and 15, the round hole 50a of the plate-shaped member 50 having passed over the head 61 is fitted on the connecting portion 62 that has a diameter larger than the diameter of the round hole 50a. Thus, the work of engaging the plate-shaped member 50 with the protrusion-shaped part 60 is completed. Thus, the round hole 50a of the plate-shaped member 50 is in a state fitted to the connecting portion 62 of the protrusion-shaped part 60 without a gap and, furthermore, the head 61, which is the large diameter portion, is disposed above the round hole 50a. As a result, the engaged state of the plate-shaped member 50 and the protrusion-shaped part 60 can be made strong and, unless work to remove the plate-shaped member 50 and the protrusion-shaped part 60 is performed with clear intent to disengage the engaged state, the engaged state of the plate-shaped member 50 and the protrusion-shaped part 60 is not easily disengaged.

As illustrated in FIG. 2, the protrusion-shaped parts 60 are provided at two locations on the head 20b of the body 20. As illustrated in FIG. 3, the plate-shaped member 50 is sewn to the exterior 10, covering the body 20, at positions corresponding to each protrusion-shaped part 60. By performing such attaching of the exterior 10 at a plurality of locations in this manner, the exterior 10 can be made to conform to the movement of the body 20, and the robot 1 that imitates a small animal can be made to perform gestures as if alive.

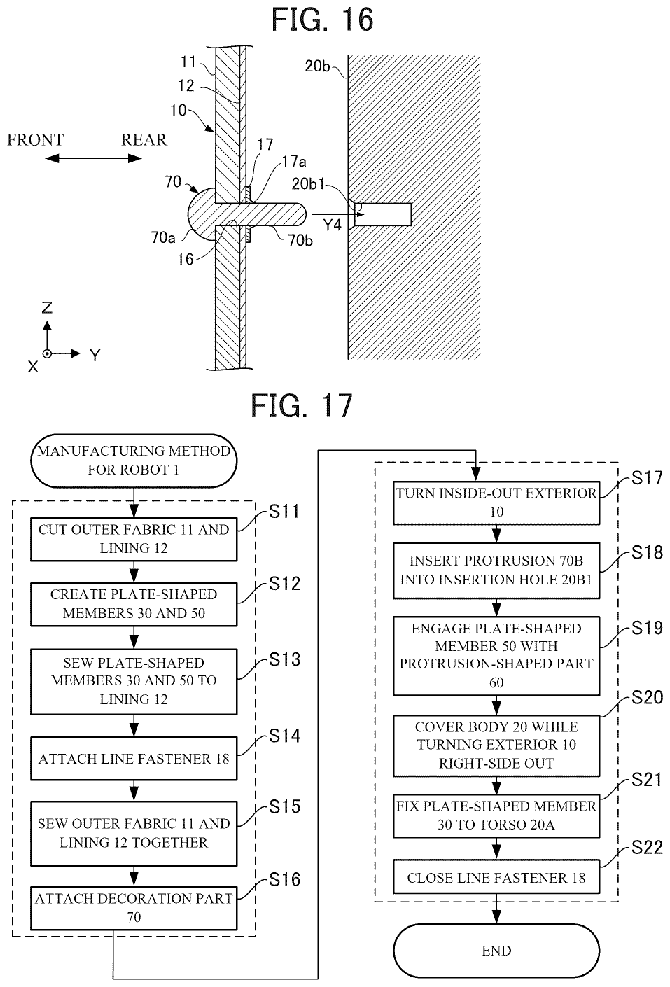

The decoration part 70 is a part imitating the eye of a small animal, as illustrated in FIG. 3. In the robot 1, by inserting the decoration part 70 into the insertion hole 20b1 formed on the head 20b, the exterior 10 can be locked to the body 20, and both of the exterior 10 and body 20 can be roughly positioned. The decoration part 70 is made of black synthetic resin, for example, to match the color of the eye of a small animal. As illustrated in FIG. 16, the decoration part 70 includes a semi-spherical decoration 70a, and a protrusion 70b that extends from the decoration 70a and protrudes from an inner side of the exterior 10. A through-hole 16 for allowing the protrusion 70b to pass through is formed in the exterior 10. The decoration part 70 is configured so that the decoration 70a is positioned on the outer fabric 11 side and the protrusion 70b is inserted into the through-hole 16. As a result, each decoration 70a is provided in a state exposed to the outside of the exterior 10, and decorates the exterior 10 as a part imitating the eye of a small animal. A washer 17 is fitted on the protrusion 70b that penetrates the exterior 10 and protrudes from the inside. The washer 17 includes a claw 17a that hooks on the threads of the protrusion 70b. As a result, the decoration part 70 can be prevented from falling out of the exterior 10.

Meanwhile, the insertion hole 20b1 into which the protrusion 70b of the decoration part 70 is inserted is formed in the head 20b that constitutes a portion of the main body 20. Due to this, the protrusion 70b is inserted into and engages with the insertion hole 20b1. The diameter of the insertion hole 20b1 is the same as or slightly larger than the diameter of the protrusion 70b. Due to this, the protrusion 70b can be easily inserted into and removed from the insertion hole 20b1. By inserting the protrusion 70b into the insertion hole 20b1, the exterior 10 can be locked onto the body 20, and misalignment between the exterior 10 and the body 20 can be prevented from occurring when attaching/detaching the exterior 10. The exterior 10 and the body 20 can be positioned, and it is possible to prevent situations such as the positional relationship between the exterior 10 and the body 20 being lost during the attaching/detaching of the exterior 10. This facilitates the work of attaching/detaching the exterior 10.

Next, a manufacturing method for the robot 1 is described while referencing FIG. 17. Firstly, an operator cut fabric for forming the outer fabric 11 and fabric for forming the lining 12 of the exterior 10 to predetermined shapes (step S11). Next, the operator punches a polyamide 6 (PA6) plate having a thickness t of 0.5 mm into a circular shape and, as illustrated in FIGS. 9 and 14, forms, in the center of the plate, the through-hole 31 through which the screw 40 is inserted or the round hole 50a through which the protrusion-shaped part 60 is inserted, thereby creating three plate-shaped members 30 and two plate-shaped members 50 (step S12). Next, as illustrated in FIGS. 6 and 7, the operator sews the created plate-shaped members 30 respectively to three predetermined locations of the lining 12. Also, as illustrated in FIG. 13, the operator sews the created plate-shaped members 50 respectively to two predetermined locations of the lining 12 (step S13). The operator then attaches the line fastener 18 illustrated in FIG. 1 (step S14). Next, the operator sews the outer fabric 11 and the lining 12 together to form a bag shape (step S15). Then, as illustrated in FIG. 16, the operator stacks the outer fabric 11 and the lining 12 on each other, forms the two through-holes 16 that penetrate the outer fabric 11 and the lining 12, and attaches the decoration parts 70 to the through-holes 16 (step S16). Thus, the creation of the exterior 10 is completed. The exterior 10 can be created by executing steps S11 to S16 in this manner.

Next, the operator attaches the created exterior 10 to the main body 20. Firstly, the operator opens the line fastener 18 illustrated in FIG. 1 and turns inside-out the exterior 10 so that the outside fur 14 is on the inside (step S17). Then, the operator, as illustrated in FIG. 16, turns right-side out the portion of the exterior 10 where the decoration parts 70 are attached, and inserts the two protrusions 70b protruding from the lining 12 into the corresponding insertion holes 20b1 illustrated in FIG. 2 (step S18). As a result, the protrusions 70b protruding from the exterior 10 can be aligned with the insertion holes 20b1 formed in the head 20b, and the exterior 10 and the body 20 can be roughly positioned. Also, by inserting the protruding protrusions 70b into the insertion holes 20b1, the exterior 10 can be locked onto the body 20 from the positioned state, and misalignments between the exterior 10 and the body 20 can be prevented. Note that when the exterior 10 is turned right-side out, it is no longer possible to view the protrusions 70b. However, the protrusions 70b are parts that protrude from the decorations 70a and, as such, provided that the decorations 70a that are on the outside can be seen, it is possible to recognize where the protrusions 70b are. As such, even when the exterior 10 is turned right-side out, the protrusions 70b can easily be inserted into the insertion holes 20b1. Next, the operator engages the plate-shaped member 50 with the protrusion-shaped part 60 (step S19). As illustrated in FIG. 14, to engage the plate-shaped members 50 with the protrusion-shaped parts 60, firstly, the round hole 50a formed in each plate-shaped member 50 is pressed against and passed over the head 61, which is the large diameter portion. Next, as illustrated in FIG. 15, the round hole 50a is fitted on the connecting portion 62, which is the small diameter part. Thus, the plate-shaped members 50 are engaged with the protrusion-shaped parts 60. Then, the operator covers the body 20 sequentially with the exterior 10 from the front side toward the back side while turning the inside-out exterior 10 right-side out (step S20). As illustrated in FIGS. 3 and 4, the operator then fixes the plate-shaped member 30 provided on the rear end portion of the exterior 10 by the screw 40 provided on the rear end portion of the torso 20a (step S21). Then, the operator entirely covers the body 20 with the exterior 10, and finally closes the line fastener 18 (step S22). By executing steps S17 to S22, the exterior 10 is attached to the body 20, and the assembly of the robot 1 is completed.

As described above, in the robot 1 according to Embodiment 1, as illustrated in FIGS. 9 and 18, the first protrusion 22-1 of the body 20 is engaged in the hole 32-1 formed in the plate-shaped member 30, thereby positioning the plate-shaped member 30 relative to the body 20. Thus, the through-hole 31 of the plate-shaped member 30 tends to be easily aligned coaxially with the screw hole 21. This allows the screw 40 to be easily inserted through the through-hole 31 of the plate-shaped member 30 and screwed into the screw hole 21, in Embodiment 1. As a result, the robot 1 that can improve the efficiency of assembling the exterior 10 onto the body 20 can be provided.

### Problem to be Solved by Embodiment 1

In the robot disclosed in Unexamined Japanese Patent Application Publication No. 2019-162715, the exterior is fixed to the body using a screw. With such a structure, efficiency in assembly is not high, leaving room for improvement in ease of assembly in the fixing method.

Embodiment 1 is made to solve the problem as above, and an objective of Embodiment 1 is to provide a robot 1 and a robot manufacturing method capable of improving efficiency in assembly of the exterior 10 to the body 20.

### Effects of Embodiment 1

Embodiment 1 can provide a robot 1 and a robot manufacturing method capable of improving the efficiency of assembling the exterior 10 to the body 20.

In the robot 1 according to Embodiment 1, the first protrusion 22-1 of the body 20 is press-fitted into the hole 32-1 formed in the plate-shaped member 30. By adjusting this press-fit force, the positioning in the thickness direction of the plate-shaped member 30 can be easily achieved. As a result, the efficiency of assembling the exterior 10 onto the body 20 can be improved.

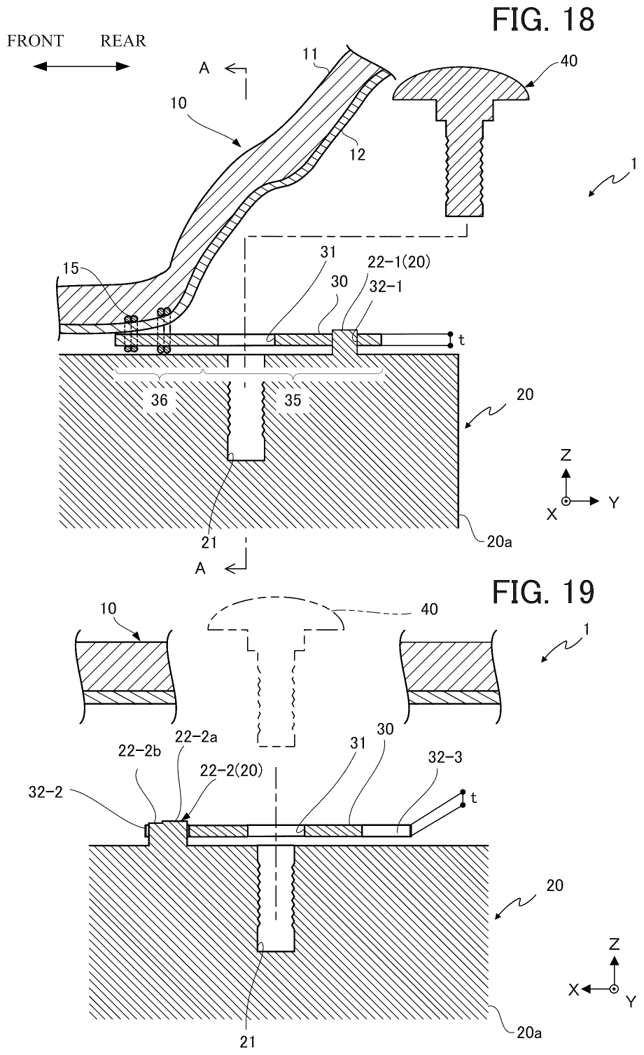

In Embodiment 1, as illustrated in FIGS. 9 and 19, the second protrusion 22-2 of the body 20 is engaged with the notch 32-2 formed on the plate-shaped member 30, thereby preventing rotation of the plate-shaped member 30 around the Z-axis relative to the body 20. This allows the screw 40 to be easily inserted through the through-hole 31 of the plate-shaped member 30 and screwed into the screw hole 21, in Embodiment 1. As a result, the efficiency of assembling the exterior 10 onto the body 20 can be improved.

For example, in a case where the plate-shaped member 30 without the notch 32-2 and the body 20 without the second protrusion 22-2 are used, the rotation prevention of the plate-shaped member 30 around the Z-axis relative to the body 20 does not occur, making the plate-shaped member 30A prone to rotate around the first protrusion 22-1. Consequently, the through-hole 31 of the plate-shaped member 30 becomes difficult to align coaxially with the screw hole 21. As a result, screwing of the screw 40 into the screw hole 21 formed in the body 20 becomes difficult, which in turn lowers the efficiency of assembling the exterior 10 onto the body 20.

By contrast, in the robot 1 according to Embodiment 1, as illustrated in FIGS. 9 and 19, the second protrusion of the body 20 is engaged in the notch 32-2 formed on the plate-shaped member 30, thereby preventing the rotation of the plate-shaped member 30 around the Z-axis relative to the body 20. Thus, the through-hole 31 of the plate-shaped member 30 tends to be easily aligned coaxially with the screw hole 21. This makes it easier to screw the screw 40 into the screw hole 21 formed in the body 20. As a result, the efficiency of assembling the exterior 10 onto the body 20 can be improved.

In Embodiment 1, as illustrated in FIGS. 6 and 7, the plate-shaped member 30 is arranged with the hole-forming section 35 in a non-fixed state relative to the inner surface of the exterior 10, while the sewing section 36 is fixed to the inner surface of the exterior 10. Therefore, in a case where a portion of the exterior 10 is when a part of the exterior 10 is peeled back from the body 20, the screw 40 screwed into the screw hole 21 can be exposed to the outside. This provides a robot 1 that can improve the efficiency of assembling the exterior 10 onto the main body 20.

In Embodiment 1, the plate-shaped members 30, 50 can be easily molded by punching, by pressing, flat plate-like polyamide 6 (PA6) having a thickness t of 0.5 mm. As such, manufacturing costs can be reduced.

In Embodiment 1, as shown in FIG. 9, the plate-shaped member 30 is formed symmetrically along the central line L3 parallel to the Z-axis direction. This allows the operator to attach the plate-shaped member 30 to the exterior 10 without worrying about the front or back of the plate-shaped member 30, as illustrated in FIGS. 18 and 19. Consequently, the efficiency of assembling the exterior 10 onto the main body 20 can be improved.

### Embodiment 2

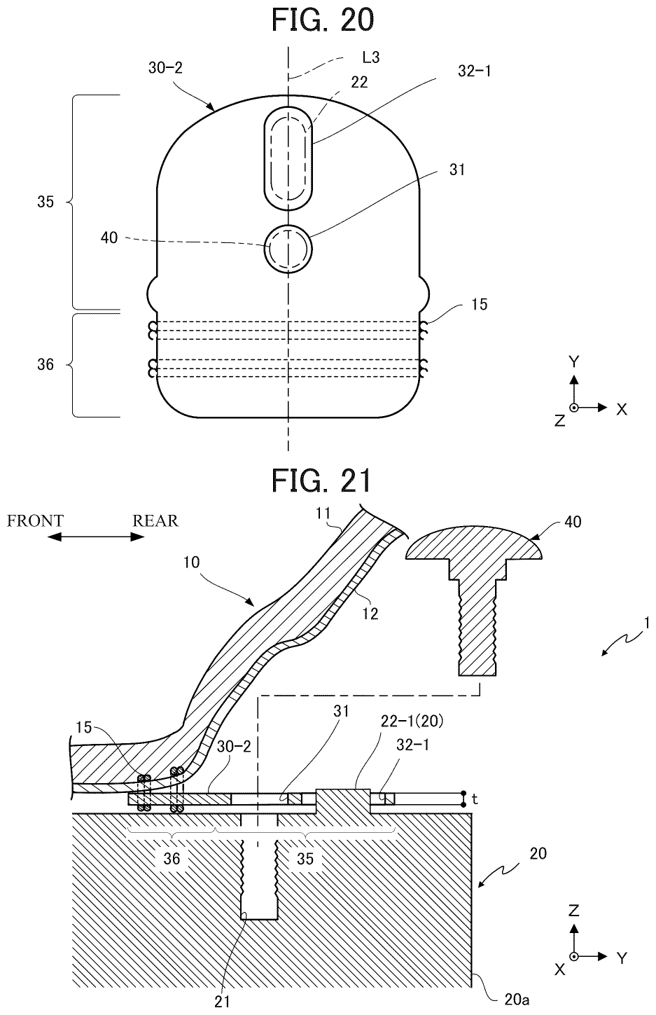

In Embodiment 1 above, as illustrated in FIG. 9, both the hole 32-1 having a positioning function and the notch 32-2 having a rotation prevention function are formed. However, the present disclosure is not limited thereto. A plate-shaped member 30-2 according to Embodiment 2, in which neither the hole 32-1 nor the notch 32-2 is formed, is described below with reference to FIGS. 20 and 21.

As illustrated in FIG. 20, the plate-shaped member 30-2 is formed symmetrically along the central line L3 parallel to the Y-axis direction. This plate-shaped member 30-2 has a through-hole 31 (attacher) and a hole 32-1 (engagement receiver). Unlike the plate-shaped member 30 according to Embodiment 1, this plate-shaped member 30-2 does not have a notch 32-2.

The screw 40 is inserted in the through-hole 31. The through-hole 31 is formed to penetrate in the thickness direction (Z-axis direction) of the plate-shaped member 30. The through-hole 31 is a circular hole with a perfectly round XY cross-section. The hole 32-1 (engagement receiver) is designed to fit the first protrusion 22-1 of the body 20. Specifically, in Embodiment 2, the first protrusion 22-1 of the body 20 is press-fitted into the hole 32-1. By adjusting this press-fit force, the positioning in the thickness direction (Z-axis direction) of the plate-shaped member 30 can be achieved. The hole 32-1 penetrates in the thickness direction (Z-axis direction) of the plate-shaped member 30. In Embodiment 2, the hole 32-1 is an elliptical hole with a long-axis XY cross-section. As illustrated in FIG. 20, this hole 32-1 is located outward on the +Y side relative to the position of the through-hole 31.

The body 20 has a screw hole 21 (attachment receiver) and a first protrusion 22-1 (engager). Unlike Embodiment 1, the body 20 according to Embodiment 2 does not have a second protrusion 22-2.

The screw hole 21 (attachment receiver), as illustrated in FIG. 21, is used to fix the plate-shaped member 30-2 to the body 20 with the screw 40. The first protrusion 22-1 (engager), as in Embodiment 1, protrudes from the surface of the body 20 and is formed in a cylindrical shape with an elliptical XY cross-section.

As described above, in Embodiment 2, as illustrated in FIGS. 20 and 21, the positioning of the plate-shaped member 30-2 relative to the body 20 is achieved by the engagement of the first protrusion 22-1 of the body 20 with the hole 32-1 formed in the plate-shaped member 30-2. Thus, the through-hole 31 of the plate-shaped member 30 tends to be easily aligned coaxially with the screw hole 21. This allows the screw 40 to be easily inserted through the through-hole 31 of the plate-shaped member 30 and screwed into the screw hole 21, in Embodiment 1. As a result, the efficiency of assembling the exterior 10 onto the body 20 can be improved.

In Embodiment 2, the hole 32-1 of the plate-shaped member 30-2 is a circular hole with an elliptical XY cross-section. The first protrusion 22-1 is also formed in a cylindrical shape with an elliptical XY cross-section. Thus, the first protrusion 22-1 of the body 20 is engaged with the hole 32-1 of the plate-shaped member 30-2, thereby preventing rotation of the plate-shaped member 30 relative to the body 20 around the Z-axis. In other words, the hole 32-1 and the first protrusion 22-1 provide not only the positioning function but also the rotation prevention function through their mutual engagement. As a result, Embodiment 1 eliminates the need to form the notch 32-2 while still allowing screw 40 to be inserted through the through-hole 31 of the plate-shaped member 30 and screwed into the screw hole 21, which in turn ultimately improves the assembly efficiency of the exterior 10 onto the body 20. Furthermore, in Embodiment 2, the same benefits as Embodiment 1 are achieved other than the improvements mentioned above.

In Embodiment 2, the hole 32-1 of the plate-shaped member 30-2 is a circular hole with an elliptical XY cross-section. The first protrusion 22-1 is also formed in a cylindrical shape with an elliptical XY cross-section. This prevents rotation of the plate-shaped member 30 relative to the body 20 around the Z-axis. However, the shapes of the hole 32-1 and the first protrusion 22-1 are not limited to these configurations. As long as the engagement of the first protrusion 22-1 with the hole 32-1 achieves rotation prevention around the Z-axis, the shapes of the hole 32-1 and the first protrusion 22-1 may differ from those described in Embodiment 2.

### Embodiment 3

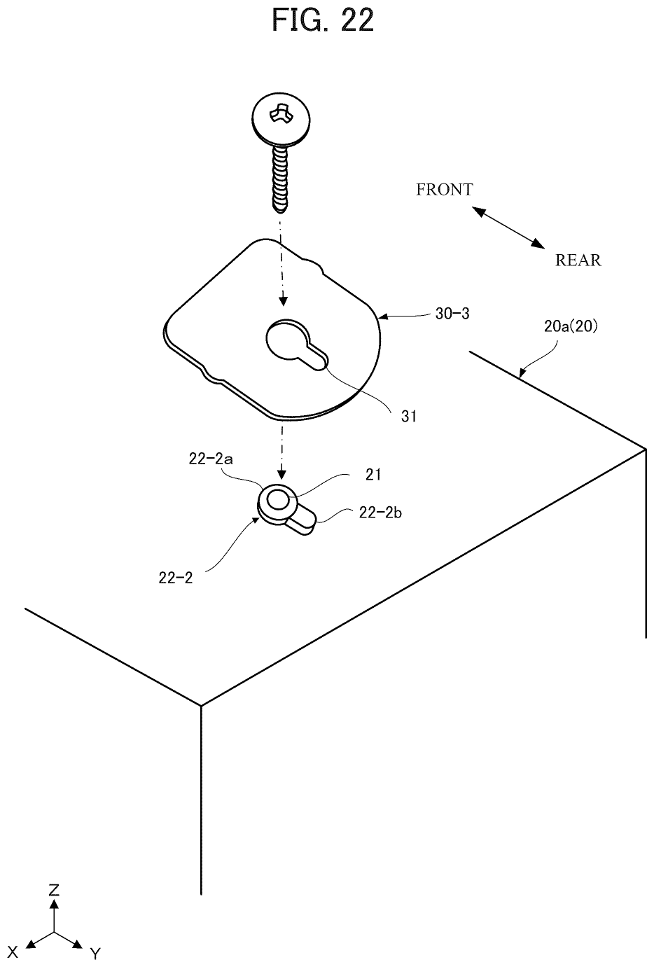

In Embodiment 1, as illustrated in FIG. 9, the hole 32-1 having a positioning function and the notch 32-2 having a rotation prevention function are formed such that a position where the plate-shaped member 30 is formed is different from a position where the through-hole 31 for screw 40 is formed. However, the present disclosure is not limited thereto. The plate-shaped member 30-3 according to Embodiment 3, where a portion having the positioning and rotation prevention functions are formed at the same position as the through-hole 31, is described below using FIGS. 22, 23, and 24.

The body 20 has a screw hole 21 (attachment receiver) and a second protrusion 22-2 (engager). Unlike Embodiment 1, the body 20 according to Embodiment 2 does not have a first protrusion 22-1.

The screw hole 21 (attachment receiver), as illustrated in FIG. 22, is used to fix the plate-shaped member 30-3 to the body 20 with the screw 40. The second protrusion 22-2 (engager), as in Embodiment 3, protrudes from the surface of the body 20 and has a cylindrical section 22-2a and a projection part 22-2b extending radially from the cylindrical section 22-2a. The screw hole 21 is provided on the upper surface of the second protrusion 22-2.

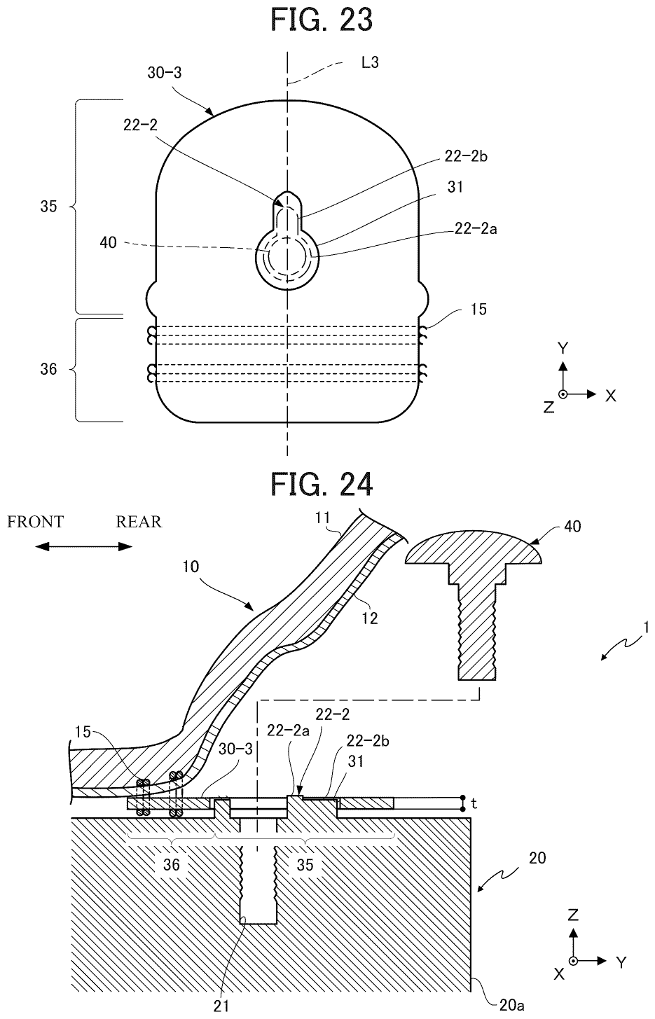

As illustrated in FIGS. 23 and 24, the plate-shaped member 30-3 is formed symmetrically along the central line L3 parallel to the Y-axis direction. This plate-shaped member 30-3 has a through-hole 31 (attacher, engagement receiver). Unlike the plate-shaped member 30 according to Embodiment 1, this plate-shaped member 30-3 does not have a hole 32-1 or a notch 32-2.

The through-hole 31 is designed to fit the second protrusion 22-2. The through-hole 31 is formed to penetrate in the thickness direction (Z-axis direction) of the plate-shaped member 30-3. The through-hole 31 is shaped to allow the second protrusion 22-2 to fit in the through-hole 31.

As described above, in Embodiment 3, as illustrated in FIGS. 22, 23, and 24, the positioning of the plate-shaped member 30-3 relative to the body 20 is achieved by engaging the second protrusion 22-2 of the body 20 with the through-hole 31 formed in the plate-shaped member 30-3. Thus, the through-hole 31 of the plate-shaped member 30 is aligned coaxially with the screw hole 21. This allows the screw 40 to be easily screwed into the screw hole 21 in Embodiment 3. As a result, the efficiency of assembling the exterior 10 onto the body 20 can be improved.

In Embodiment 3, the second protrusion 22-2 is fitted into the through-hole 31 of the plate-shaped member 30-3 to prevent the second protrusion 22-2 from rotating around the Z-axis. Thus, the plate-shaped member 30-3 is prevented from rotating around the Z-axis relative to the body 20. This eliminates the need to form the hole 32-1 and the notch 32-2 while still allowing screw 40 to be easily screwed into the screw hole 21 in Embodiment 3. As a result, the efficiency of assembling the exterior 10 onto the body 20 can be improved. Furthermore, Embodiment 3 achieves the same benefits as Embodiment 1 in addition to those mentioned above.

### Embodiment 4

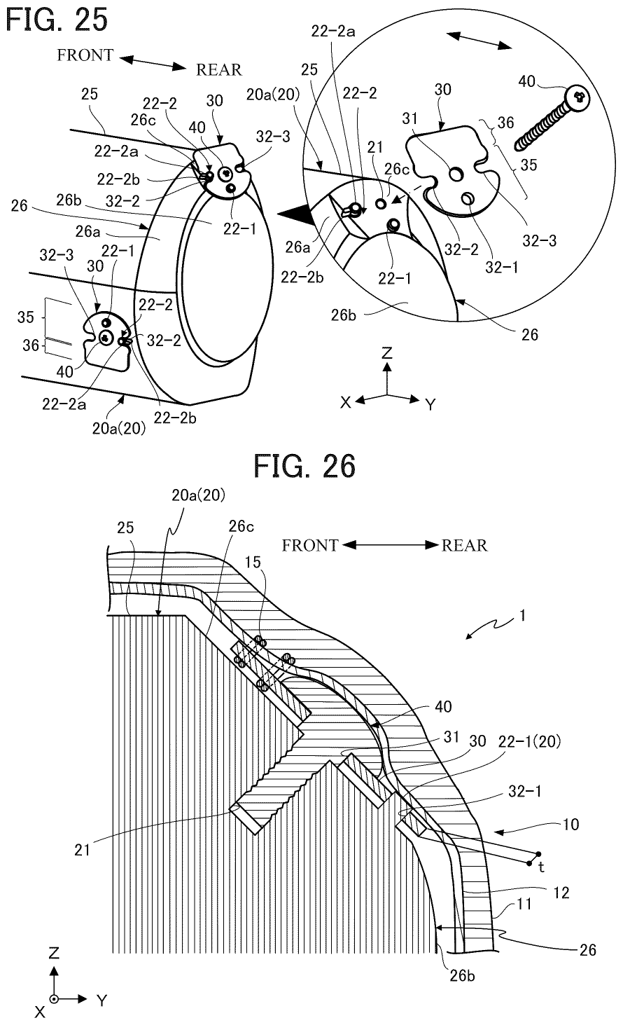

In Embodiment 1, as illustrated in FIG. 5, the rear end portion of the torso 20a is simplified and depicted as a rectangular prism. However, the rear end portion of the torso 20a may be formed in a shape other than a rectangular prism. Embodiment 4, where the shape of the torso 20a differs, is be described below with reference to FIGS. 25 and 26.

As illustrated in FIG. 25, the torso 20a is formed into a non-prismatic shape where the Y-axis direction serves as the pillar axis and the outer circumferential surface 25 around the Y-axis direction is predominantly curved. The rear end surface 26 of the +Y side of the torso 20a has a main surface 26a and a spherical protrusion 26b extending from the main surface 26a. The protrusion 26b protrudes from the main surface 26a, resulting in a portion of the main surface 26a being recessed relative to the protrusion 26b. Additionally, the rear end surface 26 has a plate-shaped member placement surface 26c for placing one of the three plate-shaped members 30. As illustrated in FIG. 26, the plate-shaped member placement surface 26c is, for example, formed as a flat surface to facilitate the attachment of the plate-shaped member 30. The plate-shaped member placement surface 26c is inclined relative to the XY plane. In Embodiment 4, the plate-shaped member placement surface 26c has a screw hole 21 (attachment receiver), a first protrusion 22-1 (engager), and a second protrusion 22-2 (engager). The screw hole 21, the first protrusion 22-1, and the second protrusion 22-2 are formed with the same shapes as those in Embodiment 1. Additionally, in Embodiment 4, the plate-shaped member 30 placed on the plate-shaped member placement surface 26c is positioned such that the end of the hole-forming section 35 side is inclined downward. Compared to Embodiment 1, where the rear end portion of the torso 20a is formed as a rectangular prism, Embodiment 4 allows for easier removal and attachment of the exterior 10 from the body 20 without snagging on corner sections or the like of the body 20. Thus, the assembly efficiency of the exterior 10 onto the body 20 is improved. Moreover, as part of the main surface 26a is recessed relative to the protrusion 26b, users can reduce the sense of foreign objects like screws and protrusions when touching the pet robot with the exterior 10 applied over the body 20. Embodiment 4 also achieves the same benefits as Embodiment 1.

### Embodiment 5

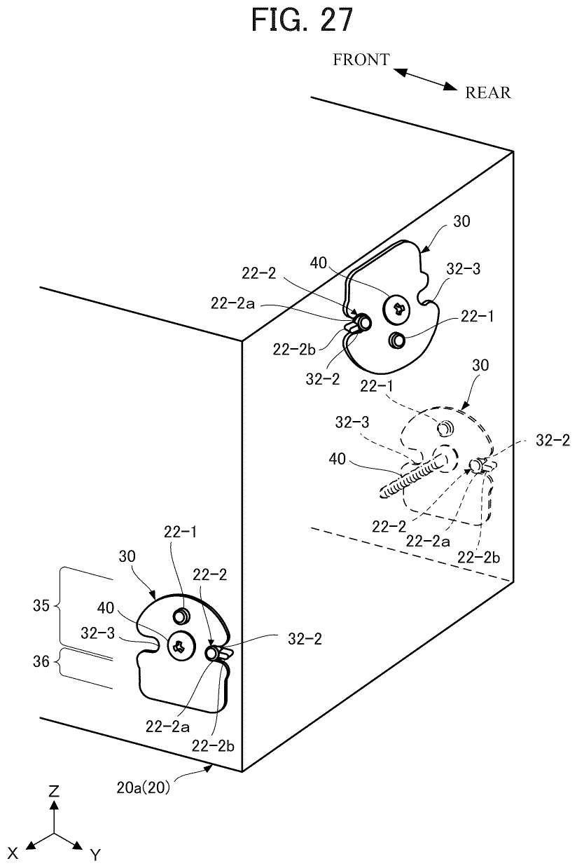

In Embodiment 1, as illustrated in FIG. 5, the rear end portion of the torso 20a is simplified and depicted as a rectangular prism. One of the three plate-shaped members 30 is arranged on the +Z side surface of the rear end portion of the torso 20a. However, the placement position of the plate-shaped member 30 is not limited to this. As illustrated in FIG. 27, the plate-shaped member 30 may also be arranged on the +Y side surface of the rear end portion of the torso 20a. Embodiment 5 also achieves the same benefits as Embodiment 1.

The embodiments of the present disclosure are described above, but the present disclosure is not limited to these embodiments.

For example, in Embodiment 1, as illustrated in FIG. 9, the body 20 has two protrusions, the first protrusion 22-1 and the second protrusion 22-2, as engagers. However, the present disclosure is not limited thereto. The body 20 may also have three or more protrusions as engagers.

In Embodiment 1, the plate-shaped member 30 has one hole 32-1 and two notches 32-2 and 32-3 formed as attachment receivers. However, the present disclosure is not limited thereto. The plate-shaped member 30 may also have one hole 32-1 and one notch 32-2 as attachment receivers.

In Embodiment 1, the plate-shaped member 30 has a hole formed to accommodate the first protrusion 22-1. However, the present disclosure is not limited thereto. The plate-shaped member 30 may also have a notch, instead of a hole, formed to accommodate the first protrusion 22-1.

In Embodiment 1, the plate-shaped member 30 has a notch formed to accommodate the second protrusion 22-2. However, the present disclosure is not limited thereto. The plate-shaped member 30 may also have a hole, instead of a notch, formed to accommodate the second protrusion 22-2.

In the embodiments described above, as an engager sewn to the exterior 10, plate-shaped members 30 and 50 are used that are molded by punching a polyamide 6 (PA6) plate. However, the material and shape of the engager can be selected as desired. For example, a configuration is possible in which a synthetic resin such as polycarbonate is used. Alternatively, a configuration is possible in which a member obtained by cutting a fabric made of chemical fibers such as polyester is used, a fabric made of natural fibers such as cotton or wool is used, or a sealing material made of rubber is used. Moreover, provided that the shape is a flat plate-like shape, the shape of the plate-shaped member 50 may have a polygonal shape such as a triangular shape or rectangular shape.

In Embodiment 1, the sewing position of the plate-shaped member 30 to the exterior 10 is described as the sewing section 36 of the plate-shaped member 30, as illustrated in FIG. 9. However, the present disclosure is not limited thereto. The sewing position of the plate-shaped member 30 to the exterior 10 may also be at other locations. For example, the sewing position of the plate-shaped member 30 to the exterior 10 may be set to a location that avoids the through-hole 31 of the plate-shaped member 30. Alternatively, a configuration is possible in which the sewing can be carried out circumferentially around the outer shape of the disk-shaped plate-shaped members 30.

The attaching of the plate-shaped members 30 to the exterior 10 is not limited to attaching by sewing using a sewing machine. For example, a configuration is possible in which the plate-shaped members 30 are sewn on by hand. Alternatively, adhesive may be applied to the circumference of the round holes 50a to affix the plate-shaped members 30. Note that, when sewing the through-holes 31 by hand, it is sufficient to form, in advance, holes in the plate-shaped members 30 for the needle to pass through. This facilitates the work of sewing by hand.

A description is given in which the thickness t of the plate-shaped members 30 is 0.5 mm, but the thickness may be changed as appropriate provided that there are no problems with the sewing by the sewing machine. Additionally, as described above, when the attaching of the plate-shaped members 30 is carried out by sewing by hand or affixing by an adhesive, thickness limitations can be relaxed. For example, a thicker flat plate-shaped member may be used, or a member formed to have different thicknesses depending on location may be used as an engaging plate.

Three of the screw holes 21 for fixing the plate-shaped members 30 are provided in the torso 20a, but the number and the formation locations of the screw holes 21 can be determined as desired in accordance with the robot 1 to which the screw holes 21 are to be applied. For example, a configuration is possible in which two of the screw holes 21 are formed and two corresponding plate-shaped members 30 are provided. Moreover, a configuration is possible in which four or more of the screw holes 21 are formed and four or more corresponding plate-shaped members 30 are provided.

A description is given in which the robot 1 imitates a small animal, but what the robot 1 imitates can be determined as desired. For example, a configuration is possible in which the robot 1 imitates a large animal such as a rhinoceros. In such a case, the decoration part may imitates the horn of the rhinoceros. A configuration is also possible in which the robot 1 imitates something other than an animal.

The exterior 10 is not limited to a form that completely covers the body 20, and a form is possible that covers a portion of the body 20. A description is given in which the exterior 10 imitates the fur of a small animal, but what the exterior 10 imitates can be determined as desired. For example, a configuration is possible in which the exterior imitates clothing worn by the robot 1, or the exterior is a banner on which an advertisement is displayed.

In the present embodiment, a description is given in which the attachment member for fixing each of the plate-shaped members 30 to the body 20 is the screw 40. Moreover, a description is given in which the attachment receiver to which the screw 40 is to be attached is the screw hole 21. However, the present disclosure is not limited thereto. A configuration is possible in which the attachment member is an engagement member other than the screw 40. Additionally, a configuration is possible in which the attachment receiver is an engagement receiver other than the screw hole 21. Furthermore a configuration is possible in which the attachment member is a member other than a member that is screwed into and engaged with the screw hole 21. For example, a configuration is possible in which the attachment member is double-sided tape, an adhesive, a member fixed by head welding, a member that is press-fitted, or a member that is hook fitted.

In the present embodiment, a description is given in which the attachment member for fixing each of the plate-shaped members 50 to the body 20 is the protrusion-shaped part 60. Moreover, the attachment receiver to which the protrusion-shaped part 60 is to be attached is the insertion hole 22. However, the present disclosure is not limited thereto. A configuration is possible in which the attachment member is an engagement member other than the protrusion-shaped part 60. A configuration is also possible in which the attachment receiver is an engagement receiver other than the insertion hole 22. Furthermore a configuration is possible in which the attachment member is a member other than a member that is screwed into and engaged with the insertion hole 22.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A robot comprising:
an exterior;
a body covered by the exterior and provided with an attachment receiver and an engager; and
a fixing member provided on an inner surface of the exterior and including an attacher disposed at a position where the attachment receiver is formed and an engagement receiver with which the engager is engaged, wherein
engagement of the engager with the engagement receiver positions the fixing member relative to the body.

2. The robot according to claim 1, wherein a position where the engagement receiver is formed in the fixing member is different from a position where the attacher is formed.

3. The robot according to claim 1, wherein the engager of the body has a first protrusion and a second protrusion as the engager.

4. The robot according to claim 3, wherein the fixing member includes, as the engagement receiver, a first fitted portion into which the first protrusion is fitted and a second fitted portion into which the second protrusion is fitted.

5. The robot according to claim 4, wherein one of the first fitted portion and the second fitted portion is a hole, and the other one is a notch.

6. The robot according to claim 1, wherein the attachment receiver is a screw hole that fixes the fixing member to the body by threading an attachment member into the attachment receiver.

7. The robot according to claim 6, further comprising the attachment member for fixing the fixing member to the body by being threaded into the screw hole.

8. A robot manufacturing method for manufacturing the robot according to claim 1, the method comprising:
forming the fixing member with a resin into a flat plate having a predetermined thickness to include the attacher that allows for insertion of an attachment member comprising a screw;
sewing the formed fixing member to a sheet-like lining of the fixing member while passing a needle of a sewing machine through portions of the fixing member other than the attacher;
after turning the lining of the exterior outward, covering the body with the exterior while turning an outer fabric of the exterior outward; and
engaging the attachment receiver provided in the body with the attacher of the fixing member by the attachment member in a state in which the body is covered with the exterior.
